(19) United States
(12) Patent Application Publication
(10) Pub. No.: US 2002/0016704 A1
(43) Pub. Date: Feb. 7, 2002

(54) Adjoint sensitivity determination for nonlinear circuit models

(76) Inventor: John P. Blanks, Portland, OR (US)

Correspondence Address: IPSOLON LLP, 805 SW BROADWAY, #2740, PORTLAND, OR, 97205, US

(21) Appl. No.: 09/881,292

(22) Filed: Jun. 13, 2001

Related U.S. Application Data
(60) Provisional application No. 60/213,856, filed on Jun. 23, 2000.

(51) Int. Cl. G06F 17/50

(52) U.S. Cl. 703/14

(57) ABSTRACT

An adjoint network method is used to determine the sensitivity of an electronic circuit model to variations in circuit components. The effects of nonlinear circuit elements are represented by augmenting the elements of the adjoint network. In particular, deviations away from linearity are represented in the original circuit by “fictitious” voltage sources. These voltage sources will map into “fictitious” current sources in the adjoint network. These sources are not static; they are directly proportional to the adjoint current through the branch corresponding to the nonlinear element. As such they may be classified as current-controlled current sources and are sometimes referred to as “correction” sources.

### TECHNICAL FIELD

The present invention relates to computerized modeling of electronic circuits and, in particular, to computerized analysis of electronic circuit sensitivities by an adjoint method.

### SUMMARY

Electronic circuit computer simulators such as SPICE, HSPICE, Spectre, etc., are commonly used to model various characteristics of electronic circuit operation. These simulators formulate and solve the nonlinear algebraic differential equations associated with an electronic circuit design, as is known in the art. To improve electronic circuit design efficiency, the sensitivity of an electronic circuit to variations in circuit components is sometimes analyzed to identify components that are particularly sensitive to variations. In this regard, circuit sensitivity quantizes the effect on the performance of a circuit caused by some variation in a circuit component.

Two main methods have been used for sensitivity computation: the direct method and the adjoint method. The direct method is efficient in the computation of several outputs with respect to one component. The adjoint method is efficient in the computation of the sensitivity of one output with respect to all the components. As a result, the adjoint method is typically more efficient in circuit sensitivity computations because most circuits have far more circuit components than outputs. A simple extension allows the adjoint method to generate the sensitivity of a function of several outputs. The adjoint method typically entails a first or original simulation of the circuit in its original form, determination of an adjoint circuit corresponding to the original circuit, and then a simulation of the adjoint circuit.

As is known in the art, nonlinearities in the original simulation may be handled by linearizing about a certain point. The quiescent or operating point is found by successively finer approximations about this point. Typically, after the operating point is found, the various nonlinear elements are treated as linear and are assigned the impedance values, etc that the elements would have at the operating point. This assures the linear circuit mimics the original nonlinear circuit at that point.

The adjoint method is invoked in order to calculate the sensitivities of observables with respect to various resistors, etc. In the usual implementation, the nonlinear devices are fixed at their operating point values. But if the circuit is changed slightly, such as by adjusting the parameters, the nonlinear devices would in reality change their impedances, etc. as the circuit changes. This change is not reflected in the fixed values used in the typical adjoint method. This is sometimes referred to as the operating point shift problem.

The present invention enhances the adjoint network method. The effects of nonlinear circuit elements are represented by augmenting the elements of the adjoint network. In particular, deviations away from linearity are represented in the original circuit by “fictitious” voltage sources. These voltage sources will map into “fictitious” current sources in the adjoint network. These sources are not static; they are directly proportional to the adjoint current through the branch corresponding to the nonlinear element. As such they may be classified as current-controlled current sources and are sometimes referred to as “correction” sources.

Accordingly, an electronic circuit sensitivity analysis method for analyzing sensitivity of an electronic circuit model as represented by electronic circuit model data includes conducting a first computer simulation of the electronic circuit model and receiving results of the first simulation. A nonlinear circuit element is identified in the electronic circuit model and a nonlinear effect of the nonlinear circuit element is represented by applying a corresponding voltage source to the electronic circuit model.

An adjoint of the electronic circuit model is generated based upon the results of the first simulation, including mapping the corresponding voltage source into a current source in the adjoint. A simulation of the adjoint of the electronic circuit model is conducted and a circuit sensitivity analysis of the electronic circuit model is conducted based upon the results of the simulations of the electronic circuit model and the adjoint to it.

Additional objects and advantages of the present invention will be apparent from the detailed description of the preferred embodiment thereof, which proceeds with reference to the accompanying drawings.

### BRIEF DESCRIPTION OF THE DRAWINGS

FIG. 1 illustrates an operating environment for an embodiment of the present invention.

FIG. 2 is a functional block diagram illustrating functions performed by an electronic circuit optimization modeling software engine.

FIG. 3 is a component block diagram illustrating an implementation of a sensitivity analysis software for performing sensitivity analysis.

FIG. 4 is a circuit schematic diagram of circuit components of a simple operational amplifier circuit to illustrate typical electronic circuit modeling.

FIG. 5 shows an ideal voltage-controlled resistor to illustrate operation of an adjoint method.

FIG. 6 is a graph showing differences between exact and uncorrected adjoint circuit characterizations.

FIG. 7 is a graph illustrating an optimization error that can arise from uncorrected adjoint circuit characterizations.

FIG. 8 illustrates a nonlinear element in which the current across the element is a function of the voltages at the two terminal nodes of the element.

FIG. 9 illustrates the nonlinear element of FIG. 8 with corresponding substitute voltage sources for nonlinear effects and a corresponding adjoint circuit.

FIG. 10 is a graph of current-voltage relationships for a gain-specified voltage-controlled current source.

FIG. 11 is a flow diagram illustrating an adjoint sensitivity method.

FIG. 12 is a schematic diagram of a circuit that is a generalization of the sample circuit of FIG. 5.

FIG. 13 is a diagram of an adjoint circuit corresponding to the circuit of FIG. 12.

FIG. 14 shows a multistage voltage-controlled resistor circuit that was used to test the adjoint network corrections described above.

FIG. 15 is graph of input voltage versus operating point voltage for the multistage voltage-controlled resistor circuit of FIG. 14.

FIG. 16 is a graph illustrating corrected and uncorrected sensitivities for multistage voltage-controlled resistors.

### DETAILED DESCRIPTION OF PREFERRED EMBODIMENTS

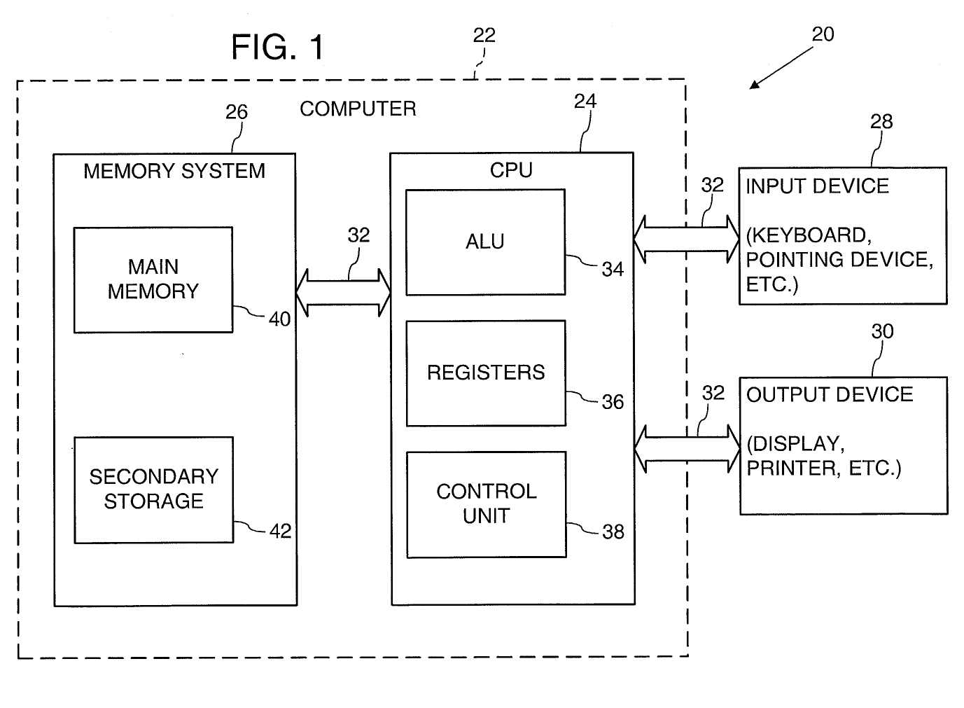

FIG. 1 illustrates an operating environment for an embodiment of the present invention as a computer system 20 with a computer 22 that comprises at least one high speed processing unit (CPU) 24 in conjunction with a memory system 26, an input device 28, and an output device 30. These elements are interconnected by at least one bus structure 32.

The illustrated CPU 24 is of familiar design and includes an ALU 34 for performing computations, a collection of registers 36 for temporary storage of data and instructions, and a control unit 38 for controlling operation of the system 20. The CPU 24 may be a processor having any of a variety of architectures including Alpha from Digital, MIPS from MIPS Technology, NEC, IDT, Siemens, and others, x86 from Intel and others, including Cyrix, AMD, and Nexgen, and the PowerPC from IBM and Motorola.

The memory system 26 generally includes high-speed main memory 40 in the form of a medium such as random access memory (RAM) and read only memory (ROM) semiconductor devices, and secondary storage 42 in the form of long term storage mediums such as floppy disks, hard disks, tape, CD-ROM, flash memory, etc. and other devices that store data using electrical, magnetic, optical or other recording media. The main memory 40 also can include video display memory for displaying images through a display device. Those skilled in the art will recognize that the memory 26 can comprise a variety of alternative components having a variety of storage capacities.

The input and output devices 28 and 30 also are familiar. The input device 28 can comprise a keyboard, a mouse, a physical transducer (e.g., a microphone), etc. In addition, input device 28 includes an optical scanner that optically scans printed and other written documents or materials (together referred to as printed documents) to generate digitized images of them. The output device 30 can comprise a display, a printer, a transducer (e.g., a speaker), etc. Some devices, such as a network interface or a modem, can be used as input and/or output devices.

As is familiar to those skilled in the art, the computer system 20 further includes an operating system and at least one application program. The operating system is the set of software which controls the computer system operation and the allocation of resources. The application program is the set of software that performs a task desired by the user, using computer resources made available through the operating system. Both are resident in the illustrated memory system 26.

In accordance with the practices of persons skilled in the art of computer programming, the present invention is described below with reference to acts and symbolic representations of operations that are performed by computer system 20, unless indicated otherwise. Such acts and operations are sometimes referred to as being computer-executed and may be associated with the operating system or the application program as appropriate. It will be appreciated that the acts and symbolically represented operations include the manipulation by the CPU 24 of electrical signals representing data bits which causes a resulting transformation or reduction of the electrical signal representation, and the maintenance of data bits at memory locations in memory system 26 to thereby reconfigure or otherwise alter the computer system's operation, as well as other processing of signals. The memory locations where data bits are maintained are physical locations that have particular electrical, magnetic, or optical properties corresponding to the data bits.

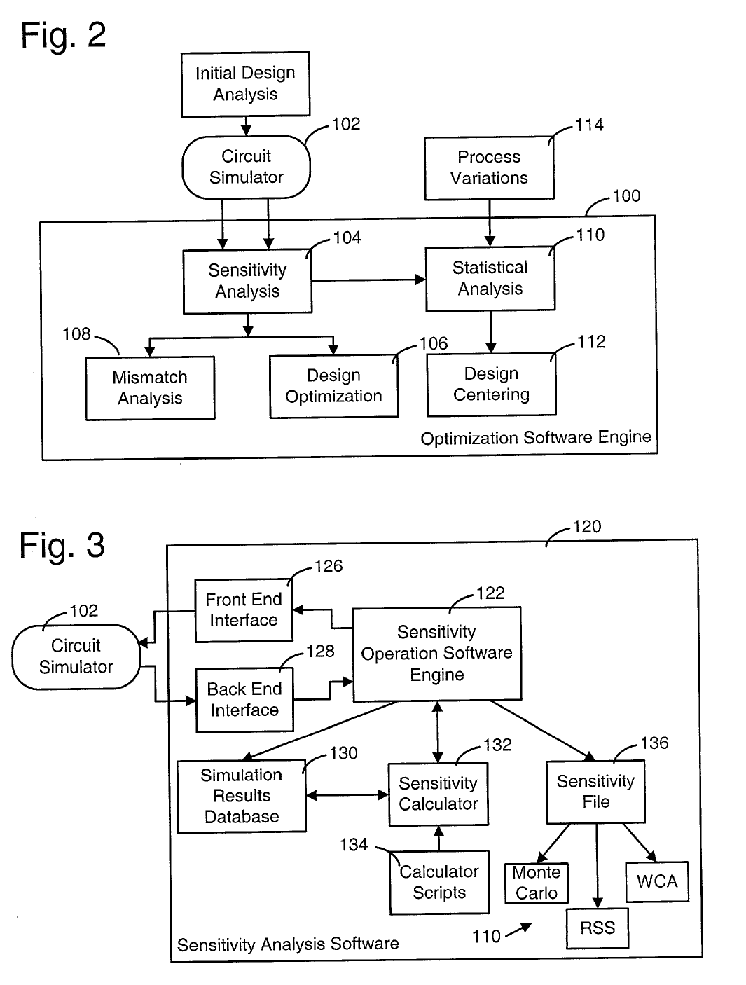

FIG. 2 is a functional block diagram illustrating functions performed by an electronic circuit optimization modeling software engine 100 that is separate from an electronic circuit simulator 102. Simulator 102 may be any widely available simulator such as such as SPICE, HSPICE, Spectre, etc., or any other custom simulator. These simulators formulate and solve the nonlinear algebraic differential equations associated with an electronic circuit design.

Optimization software 100 performs a sensitivity analysis 104 that generates sensitivity data that may be used for design optimization 106 and a mismatch analysis 108. Sensitivity analysis 104 provides information about how each circuit parameter affects the circuit output performance. This allows a circuit designer to identify parameter changes that will optimize output performance for key specifications.

Design optimization 106 may be characterized as defining a a mapping of a multi-dimensional space in which each dimension corresponds to a different design specification into a one-dimensional space by means of an objective function of the circuit. Often the full dimensionality of the parameter space is not allowed, so the problem is further constrained by additional constraint functions. In this characterization, design optimization 106 amounts to adjusting circuit performance so that quality is optimized while necessary constraints are maintained. Design optimization 106 is completed when the parameters fall within the allowed constraints and quality is optimized.

Mismatch analysis 108 minimizes the effect that individual components have on overall performance. Circuit components that match each other help to achieve the maximum circuit performance and reduce the risk that manufacturing process variations will cause the circuit to fail production tests or in an end-user system. Circuit components are considered to match each other when a circuit behavior is a function of the matching components' ratio, rather than the parameters of the individual components.

The sensitivity data generated by sensitivity analysis 104 may also be used to conduct a statistical analysis 110 that is used in design centering 112. Design centering 112 is directed to optimizing manufacturing yields. Statistical analysis 110 applies process variation data 114 that represents circuit performance characteristics associated with particular manufacturing processes to the sensitivity data. In one implementation, statistical analysis 110 employs a Monte Carlo analysis that randomly varies every parameter in the circuit design, with “trials” being generated for each set of parameter values. In other implementations, statistical analysis 110 may employ Root Sum Square Analysis (RSS) or Worst Case Analysis (WCA, sometimes referred to as Extreme Value Analysis or EVA), as are known in the art.

FIG. 3 is a component block diagram illustrating sensitivity analysis software 120 for performing sensitivity analysis 104. Sensitivity analysis software 120 includes a sensitivity software operation engine 122, sometimes called OpSens 122, which manages the operations for computing circuit output sensitivity to variations in circuit parameters and components. Sensitivity software engine 122 communicates with a separate circuit simulator 102 via a front-end interface 126 and a back-end interface 128.

Sensitivity software engine 122 and circuit simulator 102 typically would employ different data formats for electronic circuit specifications and simulations. Front-end interface 126 and back-end interface 128 provide communication and data conversion between sensitivity software engine 122 and circuit simulator 102. Simulator 102 provides circuit definition and simulation data to sensitivity engine 122 via back-end interface 128, and sensitivity engine 122 passes simulation commands to simulator 102 via front-end interface 126. Front-end interface 126 and back-end interface 128 are particularly adapted to the data format of circuit simulator 102 and allow sensitivity software engine 122 to be generically used with different circuit simulators having different data formats.

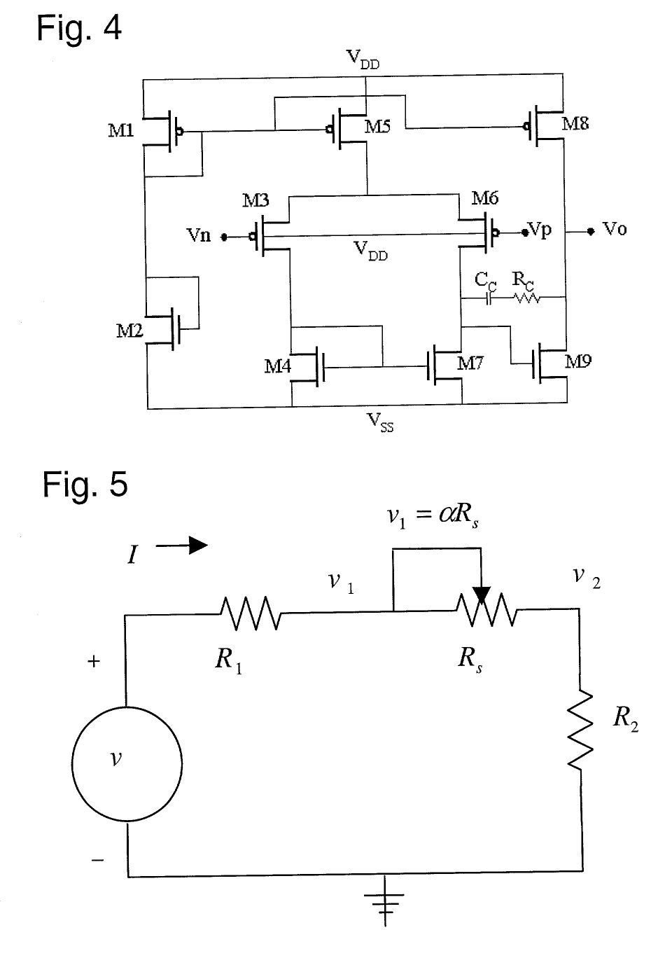

For purposes of illustration, FIG. 4 is a circuit schematic diagram of circuit components of a simple operational amplifier circuit. In one implementation, the circuit definition and simulation data may be represented as a “netlist,” which is a description of an integrated circuit design as is known in the art. In one implementation, a netlist description may have the following data structure:

*VDD 0 21 5.0
Vs 0 21 5.0
Vd 20 0 5.0
Vin in 0 AC 1 DC 1 PWL 0,−10 100u,10
*Vin in 0 AC 1 DC 1 sin(0 3 1Meg)
*Vin in 0 pulse(0 1 0 .1n .1n 1us 2us)
R1 in VN 10k tc1=−.2
R2 VN VO 10k tc1=0.2
VP VP 0 DC 0
Xop1 VO VP VN 20 21 amp
.subckt amp VO VP VN NET67 NET34
R77 NET32 VO 2E3 M=1.0 tc1=−.2
C76 NET48 NET32 1E-12 M=1.0
*V70 0 NET34 5.0
*V12 NET67 0 5.0
M6 NET48 VP NET44 NET67 PMOS L=4E-6 W=30E-6 M=1.0
M3 NET35 VN NET44 NET67 PMOS L=4E-6 W=30E-6 M=1.0
M9 VO NET48 NET34 NET34 NMOS L=3E-6 W=154.2E-6 M=1.0
M4 NET35 NET35 NET34 NET34 NMOS L=4E-6 W=15E-6 M=1.0
M7 NET48 NET35 NET34 NET34 NMOS L=4E-6 W=15E-6 M=1.0
M2 NET54 NET54 NET34 NET34 NMOS L=32E-6 W=3E-6 M=1.0
M8 VO NET54 NET67 NET67 PMOS L=4E-6 W=200E-6 M=1.0
M1 NET54 NET54 NET67 NET67 PMOS L=4E-6 W=12E-6 M=1.0
M5 NET44 NET54 NET67 NET67 PMOS L=4E-6 W=30E-6 M=1.0
.ends amp
.end

The circuit definition and simulation data are stored in a simulation results database 130. Sensitivity engine 122 cooperates with a sensitivity calculator 132 to determine sensitivity data from the circuit definition and simulation data in simulation results database 130. Sensitivity calculator 132 may be controlled by calculator scripts 134. The sensitivity data are held in a sensitivity file 136 that may be used, for example, in statistical analyses 110.

Sensitivity engine 122 uses circuit simulator 102 to simulate the selected circuit and, using data gathered from this nominal simulation, builds one or more modified adjoint circuits. Sensitivity engine 122 then uses circuit simulator 102 to simulate the one or more adjoint circuits. The outputs from these nominal and adjoint simulations are used to populate database 130 with sensitivity information for each variable in the circuit network, which allows identification of the circuit components to which the circuit outputs are most sensitive. This sensitivity information can be used for design optimization, centering, and other analyses. For example, sorting routines can assist in identifying the most sensitive parameters, thus simplifying the task for designers to reduce circuit sensitivity to component variations.

The sensitivity Sₓ^{P} is a measure of the effect on circuit performance P (sometimes called an observable) due to the variation of some circuit element x:

$${S}_{x}^{P} = \frac{x}{P} \frac{\partial P}{\partial x} .$$

Sensitivities relating to multiple parameters, as is typical, may be expressed as

$${S}_{{x}_{i}}^{P} = \frac{{x}_{i}}{P} \frac{\partial P}{\partial {x}_{i}}$$

where i indexes the parameter. The sensitivity is an indispensable tool for the design, test, and optimization of circuits. For instance, a large class of optimization methods rely heavily on gradients, which are denoted by

$$\frac{\partial P}{\partial x}$$

and give information essentially equivalent to sensitivities.

An efficient and accurate method of generating sensitivities for circuits is thus a crucial need for circuit designers.

The qualifier “efficient” is important. Sensitivities may be generated by numerical differentiation, (sometimes called the brute force, or the direct method). With this method, one parameter at a time out of the N is varied slightly, or perturbed, the simulation is rerun, and P is calculated again. The numerical derivative, and hence the sensitivity, is constructed from the difference between this value of P and the original. This is quite straightforward, but with N adjustable parameters it requires N+1 simulations at every step. With simulations correspondingly slow (likely on the order of order O(N) time at least), this results in at least O(N²) complexity. With elements running into the thousands, unmanageable run times are quickly reached.

The adjoint method, or the adjoint network method, uses techniques of linear algebra to map a circuit into a related “adjoint” circuit. A single simulation of this adjoint circuit yields the derivatives of any circuit performance measure (observable) P with respect to all parameters of interest:

$$\frac{\partial P}{\partial {x}_{i}} , i = ( 1 , 2 , … , N ) .$$

This is a very efficient method for two reasons: (1) After the original simulation, only one simulation per performance measure (P) is needed, regardless of the number of adjustable parameters. (2) The adjoint circuit is linear, even if the original circuit is not, so adjoint simulations are likely to be faster than the original. However, the statement (3) above points out a problem with the conventional adjoint circuit method. It can sometimes give inaccurate and misleading results when nonlinear elements are present in the original circuit.

Analytical Example: Conventional Adjoint Method with Nonlinear Elements

FIG. 5 illustrates an ideal voltage-controlled resistor. The resistance Rₛ, is fixed at a factor 1/α times the voltage at the first node of the resistor ν₁. This problem may be treated analytically. There is one circuit equation

ν−I(R₁+R₂+Rₛ)=0 (1)

and one equation for the resistor

ν−IR₁+αRₛ (2)

so the solution is

$${R}_{s} = \frac{- ( α {R}_{1} + α {R}_{2} - v ) + \sqrt{{( α {R}_{1} + α {R}_{2} - v )}^{2} + 4 α {R}_{2} v}}{2 α} \qquad ( 3 )$$

from which the other quantities may be easily determined.

The conventional implementation of the adjoint network method substitutes the above value of Rₛ back into the circuit equation. (In the more general nonanalytical case, this value would have been determined by a simulation.) This value of Rₛ, is fixed. Given the values (ν, R₁, R₂), the Rₛ value chosen above will be consistent, and the circuit might as well be linear.

Consider what happens when one of the parameters, say R₁, changes slightly, with the voltage μ₂ chosen as the observable. By an elementary application of the adjoint network method (or just by direct differentiation) the following may be derived:

$${( \frac{\partial {v}_{2}}{\partial {R}_{1}} )}_{U} = \frac{- {vR}_{2}}{{( {R}_{1} + {R}_{2} + {R}_{s} )}^{2}} = \frac{- {vR}_{2}}{{\overline{R}}^{2}} \qquad ( 4 )$$

where \overline{R}≡R₁+R₂+Rₛ. The U subscript designates “Uncorrected”, as explained below. By differentiating equations (1) and (2) above with respect to R₁, and eliminating

$$\frac{\partial {R}_{s}}{\partial {R}_{1}} ,$$

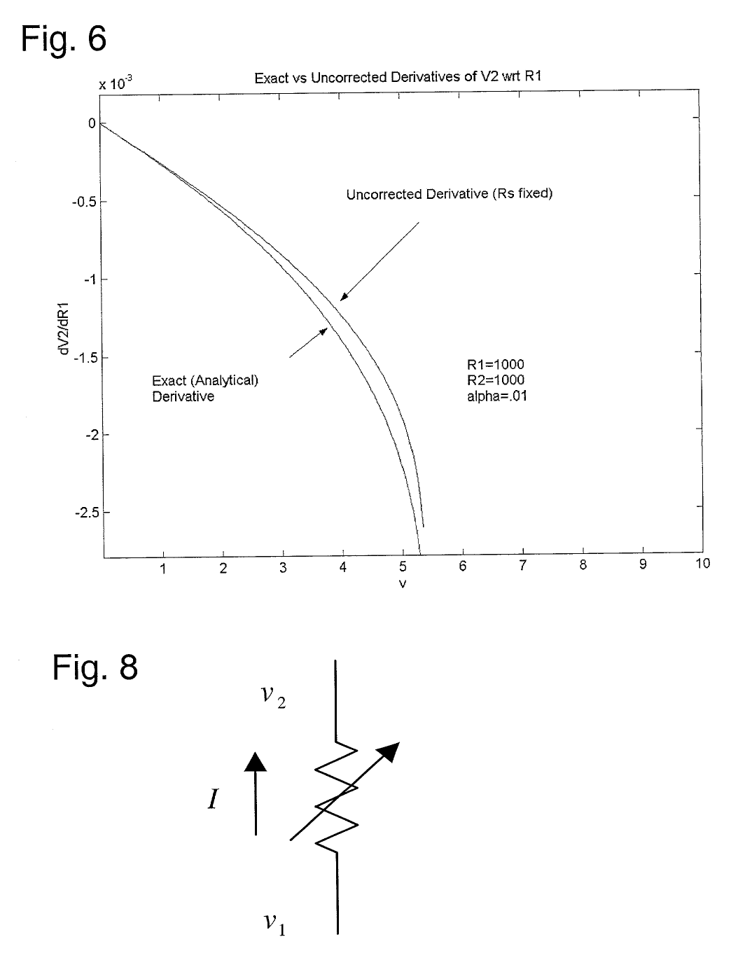

the exact, analytical result is:

$${( \frac{\partial {v}_{2}}{\partial {R}_{1}} )}_{E} = {R}_{2} \frac{\partial I}{\partial {R}_{1}} = {R}_{2} \frac{I α - {I}^{2}}{{IR}_{1} - α \overline{R}} \qquad ( 5 )$$

where the E subscript means “Exact.” The Exact and Uncorrected quantities are not the same, as the plot of FIG. 6 shows. This discrepancy can affect optimization.

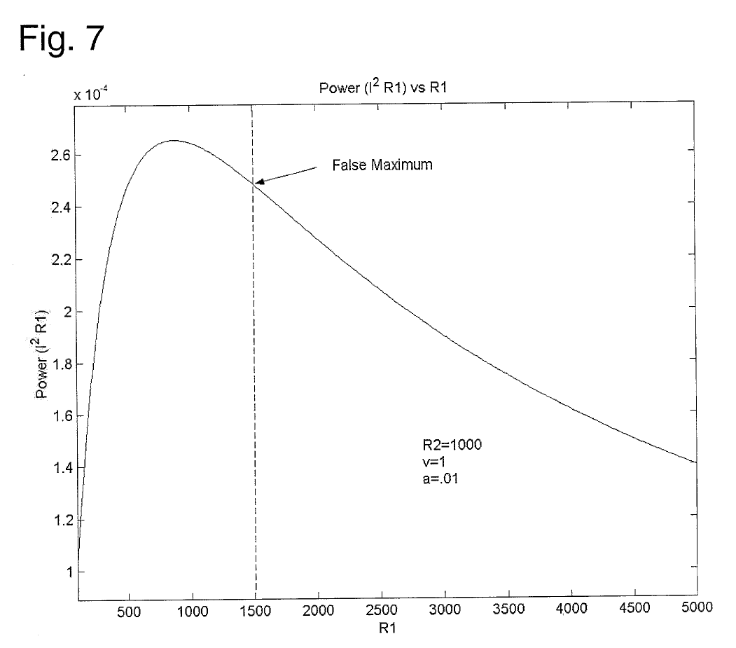

Consider an optimization that holds R₂,α, and ν constant, and maximizes the power I²R₁ across R₁. FIG. 7 is a graph of I²R₁ vs. R₁ with R2=1000,ν=,1,α=0.01. This graph shows that that the maximum power occurs at about R₁−900. But if the uncorrected values had been used (in other words set

$$\frac{\partial {R}_{s}}{\partial {R}_{1}} = 0 ) ,$$

we would have

$$P = {I}^{2} {R}_{1} = \frac{{v}^{2} {R}_{1}}{{\overline{R}}^{2}}$$

and

$$\frac{\partial P}{\partial {R}_{1}} = \frac{{v}^{2}}{{\overline{R}}^{2}} - \frac{2 {R}_{1} {v}^{2}}{{\overline{R}}^{3}}$$

with zero at R₂+R=R₁. This relation, as well as the equation ν−IR₁=αRₛ,is satisfied at the point R₂=1000,Rₛ=500,R₁=1500, I=1/(3000). However, this point is clearly not the true power maximum. (Notice this is not a problem when numerical derivatives are computed. There, slight variations of elements will be countered by self-adjustment of the nonlinear devices, and when the simulator converges the observed values are the correct ones.)

Operating Point Sensitivity Correction due to Nonlinearity

The present invention enhances the adjoint network method. The effects of nonlinear circuit elements are represented by augmenting the elements of the adjoint network. In particular, deviations away from linearity are represented in the original circuit by “fictitious” voltage sources. These voltage sources will map into “fictitious” current sources in the adjoint network. These sources are not static; they are directly proportional to the adjoint current through the branch corresponding to the nonlinear element. As such they may be classified as current-controlled current sources and are sometimes referred to as “correction” sources.

As might be expected, the coefficient by which the correction source is proportional to the adjoint current is itself a multiple of the nonlinearity of the device, as measured by the derivative of the impedance or admittance with respect to the voltage across the device. Thus, linear devices require no correction. Several common descriptions of nonlinear elements are illustrated with respect to:

(1) admittance

(2) impedance

(3) gain (g ) characterization of voltage-controlled current source Although the solution to the operating or quiescent point problem is independent of the description, it is instructive to tailor the algorithm to suit the representation at hand.

Admittance Case

FIG. 8 illustrates a nonlinear element in which the current across the element is a function of the voltages at the two nodes. For most cases of interest the current is a function only of the difference between the voltages, ν₂−ν₁. In addition, one of the nodes will be at ground. However, these conditions do not always hold; even in the simple voltage-controlled resistance above, for instance, they are violated. So the most general case will be solved, where I=I(ν₁,ν₂). It is useful to define an admittance

$$y ≡ \frac{I}{{v}_{2} - {v}_{1}}$$

where it is understood that y=y(ν₁, ν₂), unlike the linear case. This definition will allow the effect of the nonlinearity to be isolated. The case of one control will first be described, and the case of multiple controls will be described later.

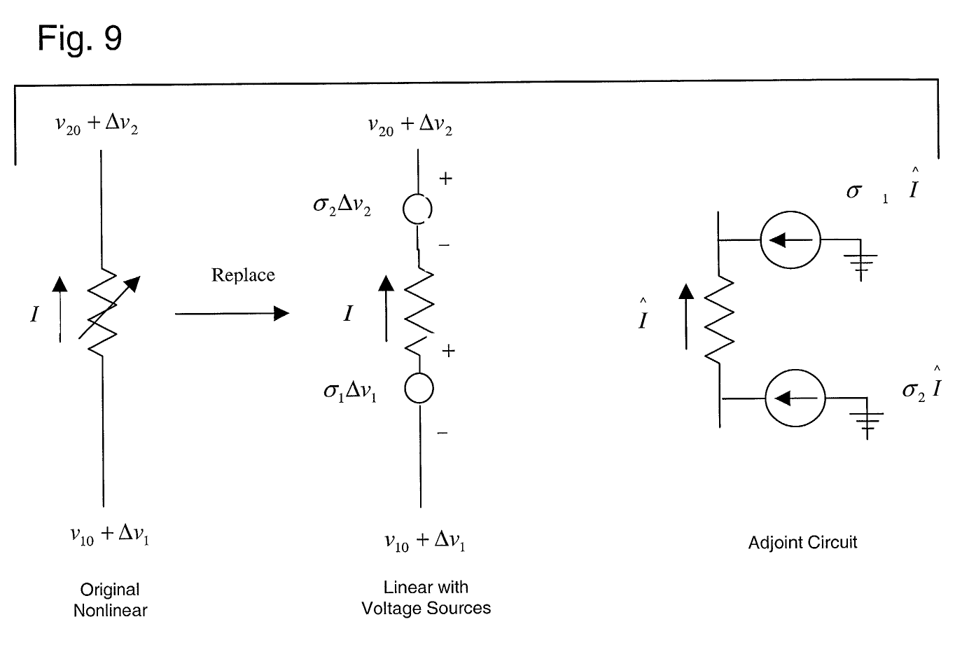

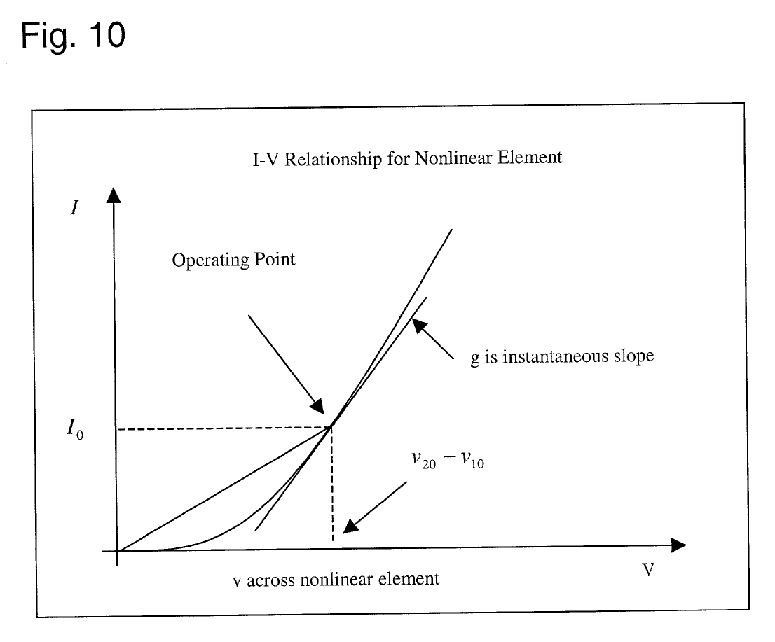

FIG. 9 illustrates the nonlinear element of FIG. 8 with its state at the quiescent or operating point O given by the values

$$( {v}_{10} , {v}_{20} , {I}_{0} , {y}_{0} ≡ \frac{{I}_{0}}{{v}_{20} - {v}_{10}} ) .$$

For perturbations about this operating point O, the admittance will be given by:

$$y = {y}_{0} + \frac{\partial y}{\partial {y}_{1}} Δ {v}_{1} + \frac{\partial y}{\partial {v}_{2}} Δ {v}_{2} ,$$

where

Δν₁=ν₁−ν₁₀,Δν₂=ν₂−ν₂₀.

As illustrated in FIG. 9, the nonlinear element may be “replaced,” to first order in Δν₁, Δν₂, with a linear element of nominal admittance y₀, plus two voltage sources σ₁Δν₁ and σ₂Δν₂ where:

$$\begin{matrix}{σ}_{1} ≡ \frac{\frac{\partial y}{\partial {v}_{1}} ( {v}_{20} - {v}_{10} )}{{y}_{0}} = \frac{\frac{\partial y}{\partial {v}_{1}} {I}_{0}}{{y}_{0}^{2}} , & ( 6 ) \\ {σ}_{2} ≡ \frac{\frac{\partial y}{\partial {v}_{2}} ( {v}_{20} - {v}_{10} )}{{y}_{0}} = \frac{\frac{\partial y}{\partial {v}_{2}} {I}_{0}}{{y}_{0}^{2}} & ( 7 )\end{matrix}$$

The nonlinear element is replaced in that the currents of the nonlinear and linear elements are the same so that the branches are indistinguishable. The current in the nonlinear element before replacement:

$$( {y}_{0} + \frac{\partial y}{\partial {v}_{1}} Δ {v}_{1} + \frac{\partial y}{\partial {v}_{2}} Δ {v}_{2} ) {( {v}_{20} + Δ {v}_{2} - {v}_{10} - Δ {v}_{1} )}_{2} )$$

can be demonstrated to be is equal to that after replacement:

y₀(ν₂₀+Δν₂−ν₁₀−Δν₁+σ₁Δν₁+σ₂Δν)

to first order. First, the zero-order terms are clearly equal; the first-order terms are:

$$( \frac{\partial y}{\partial {v}_{1}} Δ {v}_{1} + \frac{\partial y}{\partial {v}_{1}} Δ {v}_{2} ) ( {v}_{20} - {v}_{10} ) + {y}_{0} ( Δ {v}_{2} - Δ {v}_{1} )$$

and

y₀(Δν₂−Δν₁+σ₁Δν₁+σ₂Δν₂),

respectively. Subtracting the y₀(Δν₂−Δν₁) from both, and using equations (6) and (7) these are trivially equal.

This shows that a nonlinear effect may be modeled by linear elements that can be easily handled by the adjoint process. To be precise, the nonlinear effect has been incorporated into a pair of voltage sources, σ₁Δν₁=σ₁(ν₁−ν₁₀) and σ₂Δν₂=σ₂(ν₂−ν₂₀). In going to the adjoint network, the constant terms in the sources disappear, as known in the art, and the voltage sources become corresponding current sources

$${σ}_{1} \hat{I} = \frac{\frac{\partial y}{\partial {v}_{1}}}{{y}_{0}^{2}} {I}_{0} \hat{I} and {σ}_{2} \hat{I} = \frac{\frac{\partial y}{\partial {v}_{2}}}{{y}_{0}^{2}} {I}_{0} \hat{I}$$

where the I is the current through the adjoint element corresponding to the nonlinear element as shown in FIG. 9. The desired derivatives will be products like I₀ Î, as described below in greater detail with reference to a full adjoint network construction.

Impedance Case

The analysis of the shifting operating point problem using admittances is solved above, but admittances may not necessarily be the most accessible quantities. If impedances are specified, the extension is straightforward. Since

$$R = \frac{1}{y} ,$$

then:

$$\begin{matrix}{σ}_{1} = \frac{\partial ( \frac{1}{{R}_{1}} )}{\partial {v}_{1}} \frac{{I}_{0}}{{y}_{0}^{2}} = - \frac{1}{{R}^{2}} \frac{\partial R}{\partial {v}_{1}} \frac{{I}_{0}}{{y}_{0}^{2}} or & ( 8 ) \\ {σ}_{1} = - {I}_{0} \frac{\partial R}{\partial {v}_{1}} and likewise {σ}_{2} = - {I}_{0} \frac{\partial R}{\partial {v}_{2}} . & ( 9 )\end{matrix}$$

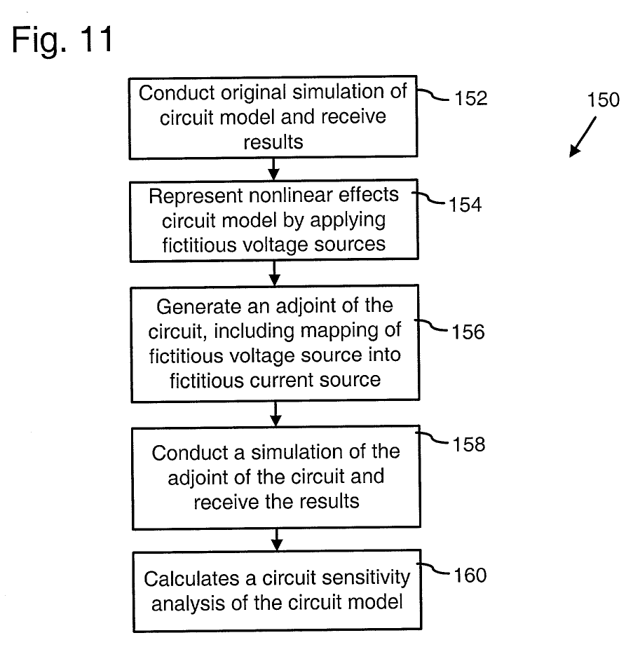

FIG. 11 is a flow diagram illustrating an adjoint sensitivity method 150. Sensitivity method 150 includes a step 152 of conducting a first or original simulation of a nominal electronic circuit specification or model and receiving results of the first simulation.

A step 154 represents the effects of nonlinear circuit elements (i.e., deviations away from linearity) in the original or nominal circuit by applying fictitious voltage sources.

A step 156 generates an adjoint of the nominal electronic circuit based upon the results of the first simulation, including mapping the fictitious voltage sources representing nonlinear circuit elements into fictitious current sources in the adjoint network.

A step 158 conduct a simulation of the adjoint of the circuit by the electronic circuit simulator and receives results of the adjoint simulation.

A step 160 calculates a circuit sensitivity analysis of the nominal electronic circuit specification based upon the results of the simulations of the nominal electronic circuit and its adjoint.

Adjoint Network Derivation

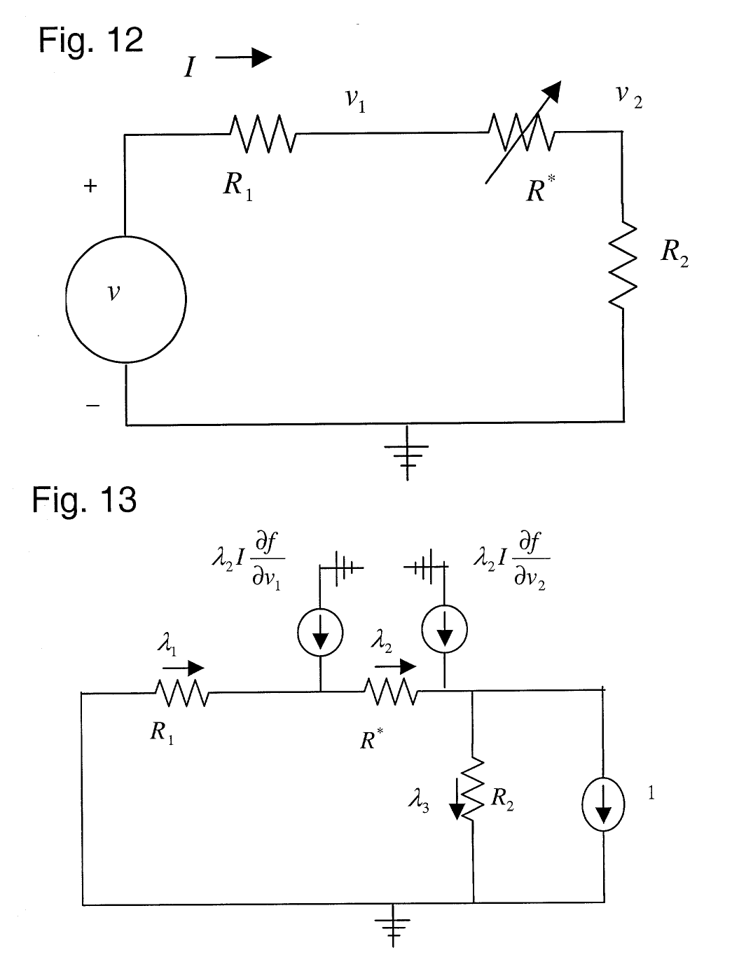

It is instructive to explore in more detail the changes introduced into the adjoint circuit. Although one could simply write down the adjoint terms corresponding to the added voltage sources, it is more instructive to re-derive the results from first principles. This derivation begins with a circuit (FIG. 12), which is a generalization of the sample circuit of FIG. 5, and uses impedances rather than admittances because of the topology of the circuit. R* designates a variable impedance of the nonlinear element. The circuit equations are

ν−IR₁−ν₁=0 (11a)

ν₁−IR*−ν₂−0 (11b)

ν₂−IR₂=0 (11c)

and the nonlinear device equation is

R*−f(ν₁,ν₂)=0 (11d)

Consider measurements of ν₂, meaning that the following are desired

$$\frac{\partial {v}_{2}}{\partial {R}_{1}} , \frac{\partial {v}_{2}}{\partial {R}_{2}} , \frac{\partial {v}_{2}}{\partial v}$$

The Lagrangian multiplier formulation is known in the art. R. A. Rohrer, “Fully Automated Network Design by Digital Computer: Preliminary Considerations,” Proc. IEEE, 55, 1929-1939 (1967). We construct the form consisting of the system variable ν₂ whose derivatives are of interest, combined with the circuit constraint equations (11):

Γ=ν₂+λ₁(ν−IR₁−ν₁)+λ₂(ν₁−IR*−ν₂)+λ₃(ν₂−IR₂)+λ₄(R*−f(ν₁,ν₂)) (12)

Then the equations are solved for the system variables:

$${{\frac{δ Γ}{δ {v}_{1}} = - {λ}_{1} + {λ}_{2} - {λ}_{4} \frac{\partial f}{\partial {v}_{1}} \vert}_{0} = 0 \\ \frac{δ Γ}{δ {v}_{2}} = 1 - {λ}_{2} + {λ}_{3} - {λ}_{4} \frac{\partial f}{\partial {v}_{2}} \vert}_{0} = 0$$

$$\frac{δ Γ}{δ I} = - {λ}_{1} {R}_{1} - {λ}_{2} {R}^{*} - {λ}_{3} {{R}_{2}}_{0} = 0$$

where the |₀ designates that values are to be taken at the operating point.

Ordinarily this would complete the analysis, however, R* is now a system variable:

$$\frac{δ Γ}{δ {R}^{*}} = - {λ}_{2} I + {λ}_{4} = 0$$

The factor λ₄ is eliminated by the last equation so that the adjoint circuit (FIG. 13) may be read off from the first three equations. These equations require the introduction of two current sources,

$${λ}_{2} I \frac{\partial f}{\partial {v}_{1}}$$

and

$${λ}_{2} I \frac{\partial f}{\partial {v}_{2}} ,$$

in exact agreement with the earlier results. The following can also be expressed:

$$\begin{matrix}\frac{\partial {v}_{2}}{\partial {R}_{1}} = \frac{δ Γ}{δ {R}_{1}} = - I {λ}_{1} & \text{(13a)} \\ \frac{\partial {v}_{2}}{\partial {R}_{2}} = \frac{δ Γ}{δ {R}_{2}} = - I {λ}_{3} & \text{(13b)} \\ \frac{\partial {v}_{2}}{\partial v} = \frac{δ Γ}{δ v} = {λ}_{1} & \text{(13c)}\end{matrix}$$

Notice, as mentioned before, that one can retrieve the derivatives of ν₂ with respect to all parameters of interest with just one adjoint simulation.

Comparison of Analytical and Adjoint Network Computations

These results can be tested directly with the voltage-controlled resistor case in which

$$f ( {v}_{1} , {v}_{2} ) = \frac{{v}_{1}}{α} , \frac{\partial f}{\partial {v}_{1}} = \frac{1}{α} and \frac{\partial f}{\partial {v}_{2}} = 0.$$

The λ equations become

−λ₁R₁−λ₂R−λ₃R₂=0

$${λ}_{2} = {λ}_{1} + \frac{I}{α} {λ}_{2} ⇒ {λ}_{1} = ( 1 - \frac{I}{α} ) {λ}_{2 }$$

λ₂=1+λ₃→λ₃=λ₂−1

We wish to show

$$\frac{\partial {v}_{2}}{\partial {R}_{1}} = - I {λ}_{1}$$

so we solve for λ₁ to get

$$- {λ}_{1} I = \frac{- {R}_{2} I ( 1 - \frac{I}{α} )}{{R}_{1} ( 1 - \frac{I}{α} ) + {R}^{*} + {R}_{2}} = \frac{{R}_{2} I ( α - I )}{{IR}_{1} - α \overline{R}} \qquad ( 14 )$$

which precisely matches the earlier result.

Experimental Results

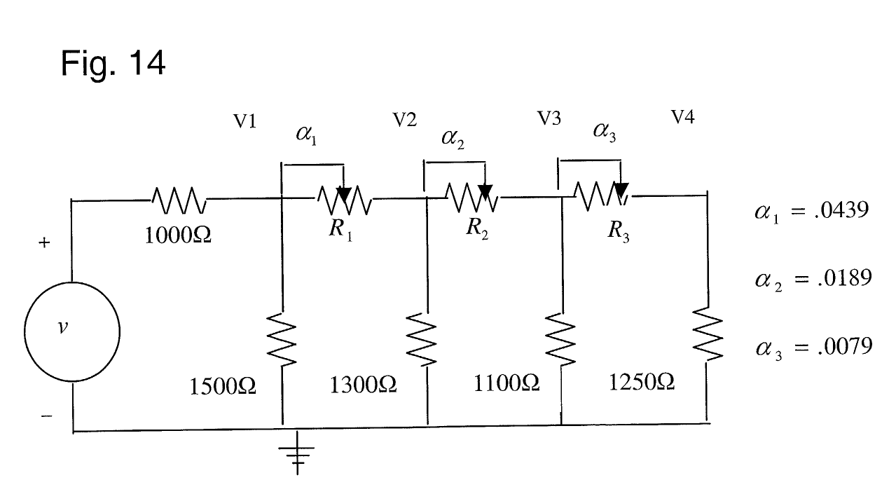

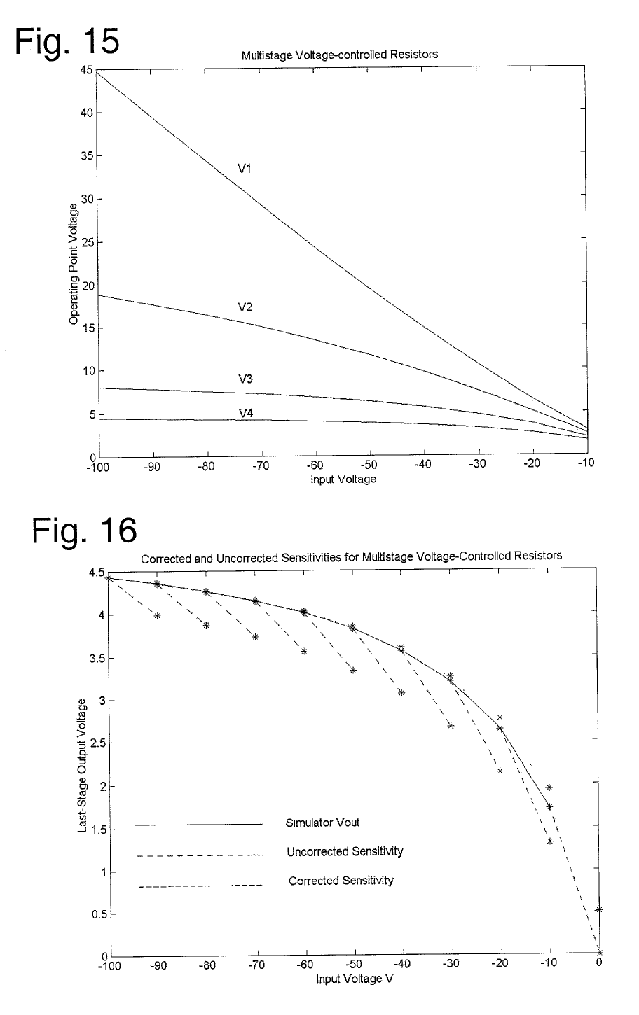

FIG. 14 shows a multistage voltage-controlled resistor circuit that was used to test the adjoint network corrections described above. A plot of the voltages at various stages is shown in FIG. 15.

FIG. 16 is a plot directed to V4 the last-stage voltage, and its sensitivity with respect to

$$v , \frac{δ {v}_{4}}{δ v}$$

(note the scale change). Here a geometric interpretation is possible.

$$\frac{δ {v}_{4}}{δ v}$$

should match the actual slope of the V4 curve . The corrected and uncorrected sensitivities are illustrated, and the disparity between the corrected and the uncorrected is clear. The accuracy of the corrected sensitivity (i.e., how well it matches the derivative) is also clear. As a check, numerical differentiation was also obtained by varying v slightly at each point. The numerical derivatives match precisely the corrected adjoint derivatives.

The CPU requirements for this case were as follows:

Original simulations: 1.68 seconds

Uncorrected Adjoint Network simulations: 0.87 seconds

Corrected Adjoint Network simulations: 0.78 seconds

Numerical derivatives (to check Corrected Adjoint): 2.85 seconds

Simulations were performed on an in-house simulator based on relaxation methods. Surprisingly, the corrected adjoint method took slightly less time than the uncorrected method. This is probably not significant. Both the original simulation and the numerical differentiation took substantially longer. This example shows convincing evidence for the efficacy of the corrected adjoint network sensitivity method for nonlinear elements.

Summary

The following table summarizes the adjoint correction mechanisms described above. This is specialized to the case where one of the nodes of the nonlinear device is at ground, the other at voltage ν. Here I₀ is the nominal, operating point current through the device, Î is the adjoint current through the device, and Î₊ is the additional adjoint current source correction.

TABLE I
Characterization and Adjoint Circuit Correction for Nonlinear Devices

| Characterization of | | Adjoint Current Source |
|---|---|---|
| nonlinear device: | I-V Relations satisfied: | Correction |
| admittance y | $y = \frac{I}{v}$ | ${\hat{I}}_{+} = \frac{\partial y}{\partial v} \frac{{I}_{0}}{{y}_{0}^{2}} \hat{I}$ |
| impedance R | $R = \frac{v}{I}$ | ${\hat{I}}_{+} = \frac{\partial R}{\partial v} {I}_{0} \hat{I}$ |

Automated design of analog and mixed-signal circuits is becoming more and more critical with increases in circuit size. Efficient and accurate calculation of sensitivities is a crucial part of that automation process. The adjoint network method is an efficient method for calculating sensitivities, but in its conventional form, is partially flawed when used in the presence of nonlinear circuit elements As described above, the method may be corrected by augmenting the adjoint circuit with current-controlled current sources whose coefficients are proportional to the measure of the nonlinearity of the device.

The operating point correction introduces current sources into the adjoint circuit. Each such source is a current-controlled current source, which is a standard circuit construct; however, an element of choice exists with regard to its implementation. Most simulators function by repeatedly solving the linear system which we indicate symbolically by ^{Ax=b} where the ^{A} represents the passive elements of the circuit, b is a source vector, and x is the state vector. Even nonlinear circuits can be solved this way, by iteration; this is how the operating point of a nonlinear circuit is found. The point is, the current source we have constructed above is now a linear function of the state vector. We can represent this by ^{b=Jx+b′}, say, where ^{J} is constant. Then we have a choice whether to solve the system ^{Ax=Jx+b′},or ^{Ax-Jx=b′} The first can be solved iteratively; the second in one step if, as is typically the case with the adjoint circuit, A is constant. Adjoint simulations are typically much faster because they are linear; it may or may not be worthwhile to modify A in order to get a quicker solution.

Having described and illustrated the principles of our invention with reference to an illustrated embodiment, it will be recognized that the illustrated embodiment can be modified in arrangement and detail without departing from such principles. In view of the many possible embodiments to which the principles of our invention may be applied, it should be recognized that the detailed embodiments are illustrative only and should not be taken as limiting the scope of our invention. Rather, I claim as my invention all such embodiments as may come within the scope and spirit of the following claims and equivalents thereto.

1. An electronic circuit sensitivity analysis method for analyzing sensitivity of an electronic circuit model as represented by electronic circuit model data, comprising:
conducting a first computer simulation of the electronic circuit model and receiving results of the first simulation;
identifying a nonlinear circuit element in the electronic circuit model and representing a nonlinear effect of the nonlinear circuit element by applying a corresponding voltage source to the electronic circuit model;
generating an adjoint of the electronic circuit model based upon the results of the first simulation, including mapping the corresponding voltage source into a current source in the adjoint;
conducting a second simulation of the adjoint of the electronic circuit model and receiving results of the second simulation; and
conducting a circuit sensitivity analysis of the electronic circuit model based upon the results of the simulations of the electronic circuit model and the adjoint to it.

2. The method of claim 1 wherein:
plural nonlinear circuit elements are identified in the electronic circuit model and nonlinear effects of the plural nonlinear circuit elements are represented by applying plural corresponding voltage sources to the electronic circuit model; and
an adjoint of the electronic circuit model is generated based upon the results of the first simulation, including mapping the plural corresponding voltage sources into current sources in the adjoint.

3. The method of claim 1 in which the current source in the adjoint to which the corresponding voltage source is mapped is a current-controlled current source.

4. The method of claim 1 in which the nonlinear effect of the nonlinear circuit element is characterized by a nonlinear admittance.

5. The method of claim 4 in which the current source Î₊ in the adjoint to which the corresponding voltage source is mapped is represented by
$${\hat{I}}_{+} = \frac{\partial y}{\partial v} \frac{{I}_{0}}{{y}_{0}^{2}} \hat{I}$$
where y is admittance, v is voltage, I₀ is a nominal, operating point current through the nonlinear circuit element, y₀ is a nominal, operating point admittance of the nonlinear circuit element, and Î is the adjoint current through the nonlinear circuit element.

6. The method of claim 1 in which the nonlinear effect of the nonlinear circuit element is characterized by a nonlinear impedance.

7. The method of claim 6 in which the current source Î₊ in the adjoint to which the corresponding voltage source is mapped is represented by
$${\hat{I}}_{+} = - \frac{\partial R}{\partial v} {I}_{0} \hat{I}$$
where R is impedance, v is voltage, I₀ is a nominal, operating point current through the nonlinear circuit element, and Î is the adjoint current through the nonlinear circuit element.

8. In an electronic circuit sensitivity analysis method for analyzing sensitivity of an electronic circuit model as represented by electronic circuit model data and employing an adjoint of the electronic circuit model, the improvement comprising:
identifying a nonlinear circuit element in the electronic circuit model and representing a nonlinear effect of the nonlinear circuit element by applying a corresponding voltage source to the electronic circuit model; and
generating the adjoint of the electronic circuit model with a mapping of the corresponding voltage source into a current source in the adjoint.

9. In an electronic circuit sensitivity analysis method for analyzing sensitivity of an electronic circuit model as represented by electronic circuit model data and employing an adjoint of the electronic circuit model, the improvement comprising:
identifying in the electronic circuit model a nonlinear circuit element having a nonlinear effect; and
generating the adjoint of the electronic circuit model with a current source representing the nonlinear effect of the nonlinear circuit element.

10. The method of claim 9 wherein:
plural nonlinear circuit elements are identified in the electronic circuit model and have nonlinear effects; and
the adjoint of the electronic circuit model is generated plural current sources representing the nonlinear effects of the plural nonlinear circuit elements.

11. The method of claim 9 in which the nonlinear effect of the nonlinear circuit element is characterized by a nonlinear admittance.

12. The method of claim 11 in which the current source Î₊ in the adjoint is represented by
$${\hat{I}}_{+} = \frac{\partial y}{\partial v} \frac{{I}_{0}}{{y}_{0}^{2}} \hat{I}$$
where y is admittance, v is voltage, I₀ is a nominal, operating point current through the nonlinear circuit element, y₀ is a nominal, operating point admittance of the nonlinear circuit element, and Î is the adjoint current through the nonlinear circuit element.

13. The method of claim 9 in which the nonlinear effect of the nonlinear circuit element is characterized by a nonlinear impedance.

14. The method of claim 13 in which the current source Î₊ in the adjoint is represented by
$${\hat{I}}_{+} = - \frac{\partial R}{\partial v} {I}_{0} {I}^{\hat{}}$$
where R is impedance, v is voltage, I₀ is a nominal, operating point current through the nonlinear circuit element, and Î is the adjoint current through the nonlinear circuit element.

15. In an computer readable medium, electronic circuit sensitivity analysis software for analyzing sensitivity of an electronic circuit model as represented by electronic circuit model data and employing an adjoint of the electronic circuit model, the improvement comprising:
software for identifying a nonlinear circuit element in the electronic circuit model and representing a nonlinear effect of the nonlinear circuit element by applying a corresponding voltage source to the electronic circuit model; and
software for generating the adjoint of the electronic circuit model with a mapping of the corresponding voltage source into a current source in the adjoint.

16. In a computer readable medium, electronic circuit sensitivity analysis software for analyzing sensitivity of an electronic circuit model as represented by electronic circuit model data and employing an adjoint of the electronic circuit model, the improvement comprising:
software for identifying in the electronic circuit model a nonlinear circuit element having a nonlinear effect; and
software for generating the adjoint of the electronic circuit model with a current source representing the nonlinear effect of the nonlinear circuit element.

17. The medium of claim 16 wherein:
plural nonlinear circuit elements are identified in the electronic circuit model and have nonlinear effects; and
the adjoint of the electronic circuit model is generated plural current sources representing the nonlinear effects of the plural nonlinear circuit elements.

18. The medium of claim 16 in which the nonlinear effect of the nonlinear circuit element is characterized by a nonlinear admittance.

19. The medium of claim 18 in which the current source Î₊ in the adjoint is represented by
$${\hat{I}}_{+} = \frac{\partial y}{\partial v} \frac{{I}_{0}}{{y}_{0}^{2}} \hat{I}$$
where y is admittance, v is voltage, I₀ is a nominal, operating point current through the nonlinear circuit element, y₀ is a nominal, operating point admittance of the nonlinear circuit element, and Î is the adjoint current through the nonlinear circuit element.

20. The medium of claim 16 in which the nonlinear effect of the nonlinear circuit element is characterized by a nonlinear impedance.

21. The medium of claim 20 in which the current source Î₊ in the adjoint is represented by
$${\hat{I}}_{+} = - \frac{\partial R}{\partial v} {I}_{0} \hat{I}$$
where R is impedance, v is voltage, I₀ is a nominal, operating point current through the nonlinear circuit element, and Î is the adjoint current through the nonlinear circuit element.
